(19) United States
(12) Patent Application Publication
(10) Pub. No.: US 2026/0148393 A1
(43) Pub. Date: May 28, 2026

(54) DETECTING AND TRACKING OBJECTS USING SENSOR DATA

(71) Applicant: Black Sesame Technologies Inc., San Jose, CA (US)

(72) Inventors: Xinrui Zhang, San Jose, CA (US); Zilong Hu, San Jose, CA (US); Lei Zhang, San Jose, CA (US)

(21) Appl. No.: 18/959,373

(22) Filed: Nov. 25, 2024

(51) Int. Cl. G06T 7/292; G06T 3/00; G06T 7/246; G06T 7/73; G06V 10/74; G06V 10/762; G06V 10/80; G06V 10/82; G06V 20/58

(52) U.S. Cl. CPC G06T 7/292; G06T 3/00; G06T 7/248; G06T 7/73; G06V 10/74; G06V 10/762; G06V 10/80; G06V 10/82; G06T 2207/10016; G06T 2207/20084; G06T 2207/30252; G06V 20/58

(57) ABSTRACT

Methods, systems, and apparatuses, including computer programs encoded on computer storage media, for receiving a respective sequence of sensor data from each of a plurality of sensors, processing each of the respective sequences of sensor data using a neural network to generate a respective network output that represents detection and tracking information for corresponding objects captured in the respective sequence of sensor data; for each of the respective network outputs, transforming the respective network output to a bird's eye view (BEV) space to generate a BEV data sequence representing a set of tracked objects in the BEV space; and generating characteristic information for at least a portion of the set of tracked objects based on the BEV data sequence.

### BACKGROUND

This specification relates to detecting and tracking objects using multiple sensor data, particularly to fusing sensor data received from multiple sensors to detect and track objects captured in the sensor data.

Object detection plays a pivotal role in the advancement of autonomous vehicles, enabling them to perceive and comprehend their surroundings accurately and in real-time. Various object detection algorithms can be implemented to process sensor data for identifying and classifying objects such as pedestrians, vehicles, cyclists, and road signs, ensuring the safety of passengers and other road users and facilitating efficient navigation and decision-making processes for autonomous vehicles.

Sensor data can have different forms and be collected by various sensors, e.g., image sensors, optical sensors, etc. An image sensor can capture a sequence of image frames and stream the sequence to a processor in real time for downstream processing. Each image frame represents a scene representing one or more objects. An optical sensor can include a light detection and ranging (LiDAR) sensor, which can generate a three-dimensional point cloud for each frame of multiple frames based on reflected optical signals for the frame.

Neural networks can be implemented to process data captured by sensors. They generally include different neural network layers to process sensor data (e.g., images) for different tasks, such as detection, tracking, classification, prediction, segmentation, etc.

### SUMMARY

This specification describes techniques related to monitoring and tracking objects captured by multiple sensors with enhanced accuracy. More specifically, the described techniques can project sensor data from multiple sensors into a bird's eye view (BEV) space using one or more transformation matrices. For example, homography transformation matrices can be used for transferring image sensor data to the BEV space, and affine transformation matrices for LiDAR-to-BEV transformation. The described techniques can further fuse detection and tracking information determined for the sensor data by a neural network to generate BEV data sequences in the BEV space and extract characteristic information for tracked objects from the BEV data sequences. The characteristic information in the BEV space is determined by inferring characteristic information of tracked objects in the sensor data generated by the neural network processing the sensor data. By fusing information from the sensor data obtained from multiple sensors into the BEV space, the described techniques accordingly can address the occlusion issues that harm the detection and tracking performance when only data obtained by a single sensor is processed.

One aspect of the subject matter described in this specification can be embodied in a method for detecting and tracking objects in the BEV space from sensor data captured by multiple sensors. More specifically, the method includes receiving respective sequence of sensor data from each of multiple sensors. The sensors can have different types, e.g., image sensors, optical sensors, or other suitable sensors. The method further includes processing each of the respective sequences of sensor data using a neural network to generate a respective network output that represents detection and tracking information for corresponding objects captured in the respective sequence of sensor data. The method further includes, for each of the respective network outputs, transforming the respective network output to a BEV space to generate a BEV data sequence representing a set of tracked objects in the BEV space. In general, the method can map information from the image space to the BEV space using transformation matrices and predictions in the image space for sensor data using a machine learning model. The method further includes generating characteristic information for at least a portion of the set of tracked objects based on the BEV data sequence. The extracted characteristic information can be used for downstream operations and applications such as traffic prediction or traffic warnings.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

Particular embodiments of the subject matter described in this specification can be implemented to realize one or more of the following advantages. For example, the described techniques can improve the accuracy, robustness, efficiency, and compatibility of detecting and tracking objects captured sensor data from multiple sensors.

The described techniques offer significant advantages in enhancing the accuracy of detecting and tracking objects. By integrating sensor data from multiple sources and projecting this processed data into a bird's Eye View (BEV) space, these techniques effectively address the limitations inherent in using a single sensor. For instance, when a single sensor encounters occlusions—where objects are partially or fully blocked from view—this approach enables the system to rely on data from other sensors to fill in the gaps. This multi-sensor fusion mitigates the blind spots and improves the reliability of object detection and tracking. Additionally, because the fusion operations are conducted within the BEV space, the system benefits from a unified perspective that combines inputs from various angles and viewpoints, enhancing the depth and richness of the detected data. The tracked objects within the BEV space have tangible, physical significance, as they correspond to real-world objects detected from multiple sensor perspectives. This correspondence allows for straightforward validation against ground truth data, such as that captured by LiDAR sensors or aerial imagery from drones, ensuring higher fidelity and accuracy in the detection process.

Further, the described techniques are cost-efficient and readily scalable, which is suitable for a wide range of applications. A key advantage lies in the ability to train a single machine-learning model to detect and track objects across a sequence of data from various sensors observing a scene. This trained model can then be applied to process sensor data from other similar scenes without the need for retraining. Instead, adapting to new scenes only involves updating one or more transformation matrices, which couple the sensor space of multiple sensors and the BEV space. As described above, the transformation matrices can include homography transformation matrices for image-to-BEV mapping and affine transformation matrices for LiDAR-to-BEV mapping. For simplicity, the description below is described with respect to homography transformation matrices, but it should be noted that other types of transformation matrices can be used for different mapping requirements.

The one or more homography transformation matrices can be efficiently obtained by calibrating the coordinates of the sensors in the BEV space, where the BEV space can be determined by a drone or Lidar configured to capture a BEV image (or top-down image) of a scene. The described techniques accordingly can reduce the need for repeated model training, saving time and computational resources.

Furthermore, the described techniques can be effortlessly expanded to incorporate additional sensors, such as cameras, radar, LiDAR, or any other suitable sensing devices. This capability to augment the system with new sensor data allows for richer environmental perception and improved detection accuracy, adapting to complex scenarios that may require enhanced sensor coverage. For example, adding more cameras can enhance visual coverage, while additional radar or LiDAR sensors can provide more detailed information about object distances and velocities, even in adverse weather conditions. This extensibility ensures that the described techniques can evolve with new technologies and remain effective in dynamic environments, providing a robust and future-proof solution for object detection and tracking.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of a bird's eye view (BEV) object tracking system configured to process input data to generate output data.

FIG. 2 is a flow diagram of an example process for generating a homography transformation matrix.

FIG. 3 illustrates an example of correspondence between points in a BEV image and an image captured by a camera.

FIG. 4 illustrates an example of determining the center point of a tracked object in the BEV space.

FIG. 5 is a flow diagram of an example process for processing input data to detect unlabeled objects.

Like reference numbers and designations in the various drawings indicate like elements.

### DETAILED DESCRIPTION

The described techniques relate to detecting and tracking one or more objects using sensor data captured by multiple sensors. Unlike existing techniques, where each sensor captures a different portion of a scene and the single-sensor data is then fused to create a bird's eye view (BEV) using conventional camera calibration techniques, the described techniques involve processing data from multiple sensors capturing a common scene with a trained machine learning model. The network output is then projected into a BEV space using homography information calibrated by multiple sensors and a BEV image, typically a top-down image of the common scene captured by sensors such as LiDAR or a drone. In this way, the described techniques address the limitations of using a single sensor for object detection and tracking. For instance, objects may be occluded from the perspective of a single sensor, making them challenging to detect. By fusing sensor data (or machine learning model outputs) from different sensors with various perspectives into the BEV space, the techniques compensate for occluded objects or object parts, enhancing the accuracy and performance of object detection and tracking.

For example, the machine learning model processing the sensor data may be a trained convolutional neural network designed to process a sequence of sensor data and generate output representing detection and tracking information for one or more objects. Importantly, the neural network operations are performed in the sensor data space rather than in the BEV space. Following this, the described techniques generate BEV representations of the objects based on the model's output and produce a set of tracked objects in the BEV space using these BEV representations.

The described techniques can further extract characteristic information of the detected and tracked objects in the BEV space for various applications, such as real-time traffic updates, hazard warnings, and other relevant applications. These techniques can be combined with additional operations to provide proactive safety measures based on the extracted information, further enhancing road safety. The extracted information may include the tracked object's BEV location, dimensions, heading direction, and even a visual representation of the tracked object.

Moreover, the described techniques detect and track objects using bounding boxes in the BEV space, which are clustered and assigned to different tracked objects with unique identifiers. Using the same trained machine learning model, the identifiers and bounding boxes in the BEV space are determined based on those predicted for the objects during sensor data processing. The described techniques accordingly further improve the detection and tracking accuracy by using bounding boxes instead of point clouds in the BEV space.

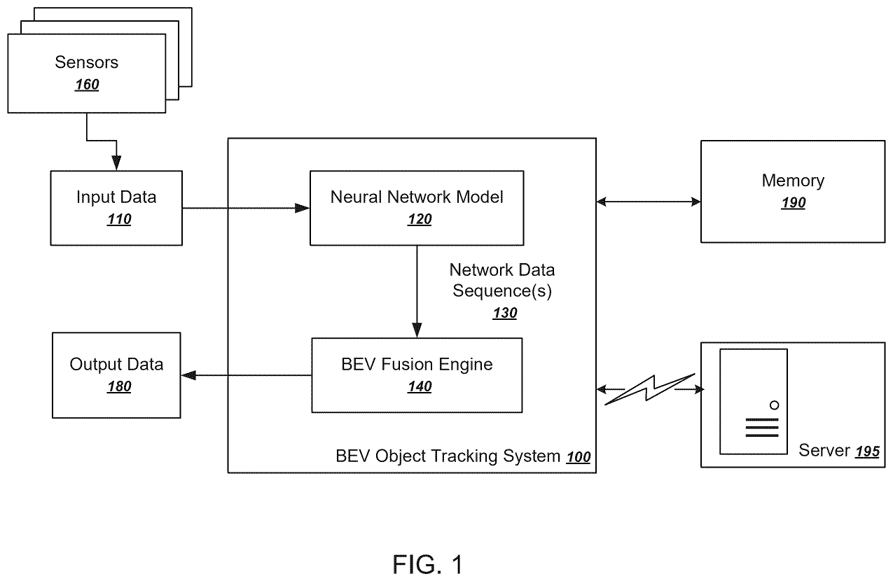

FIG. 1 illustrates an example of a bird's eye view (BEV) object tracking system 100 configured to process input data 110 to generate output data 180. The BEV object tracking system 100 can be implemented on one or more computers or processors at one or more locations. The one or more computers or processors can be coupled with one another wirelessly or by wires. The one or more computers or processors can include one or more CPUs, GPUs, TPUs, or other suitable types of processors. For simplicity, the BEV object tracking system 100 is referred to as system 100 in the following description.

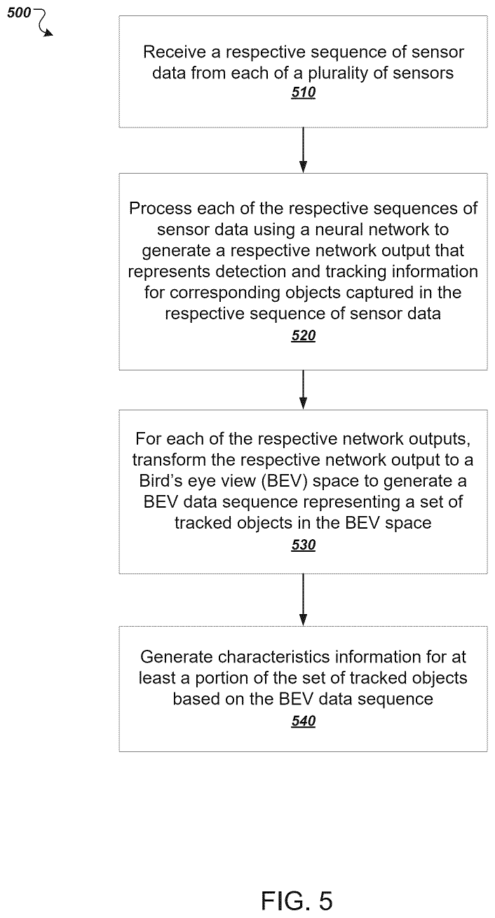

As shown in FIG. 1, system 100 can include one or more modules that are configured to perform different operations to process input data 110. For example, system 100 includes a neural network model 120 to receive and process input data 110 to generate network data sequence(s) 130. The network data sequence 130 is then passed into BEV fusion engine 140 of system 100 to generate output data 180. Details of the operations performed by the neural network model 120 and the BEV fusion engine 140 are briefly described below, and more details are described in connection with FIG. 5.

Input data 110 generally includes sensor data collected or generated through different sensors capturing a common scene from different perspectives. In detecting and tracking objects on a road, the multiple sensors are generally located on or near the road with a perspective orientation facing the road. For example, the road can be a crossroad, and the multiple sensors can be removably attached to a rod (e.g., a traffic rod or the rod having the traffic lights). The crossroad, for example, can include a four-way crossroad, a three-way crossroad, or a forked road, or a regular road with no forks. Note that the sensors described in the following description are generally fixed in respective orientations relative to the road - not attached or located on a moving object, e.g., an autonomous driving vehicle.

The input data 110 generally relates to multiple sequences of data, each sequence of data captured by one of the multiple sensors from a respective perspective capturing the common scene. In addition, each sequence of data includes multiple frames according to temporal order, and each frame in the sequence of data can include a respective set of objects at respective locations with respective heading directions. This is because one or more objects can move in and out of the scene at different temporal points such that the one or more objects become measurable or unmeasurable at those temporal points by the multiple sensors. The above-noted sensors can include image sensors such as cameras, video recorders, surveillance cameras, etc. In some implementations, those sensors can include LiDAR sensors, radar sensors, or other suitable sensors.

For situations where the sensors are cameras, the input data 110 can include a sequence of two-dimensional (2D) image frames captured by each camera of multiple cameras. Each image of the sequence of 2D image frames can include pixels representing one or more objects captured in the scene by the corresponding camera. The pixels can represent semantic information for a vehicle, a pedestrian, a road sign, etc. In some implementations, the pixels in a 2D image frame can represent additional objects such as the road surface where a vehicle operates, objects away from the road (i.e., on the curbsides or in the opposite lane or the bike lane of the road), non-human beings such as cats, dogs, or other types of animals, road cones, construction signs, etc. That said, although the description above illustrates sensors such as image sensors, LiDARs, and radars for ease of explanation, it should be noted that the described techniques can be applied to other sensor data collected or generated by other types of sensors, according to different requirements for detecting and tracking objects.

System 100 then processes the input data 110 using the neural network model 120 to generate network data sequences 130. More specially, since the input data 110 includes multiple sequences of data collected by multiple sensors, the neural network model 120 is trained to process each sequence of data collected by one of the multiple sensors to generate a respective network data sequence 130. Each network data sequence 130 represents a set of two-dimensional bounding boxes for one or more objects captured in each frame of a plurality of frames in the network data sequence 130. The neural network model 120 can be trained using supervised training techniques, where the training samples include reference labels for detecting and tracking objects that are captured in a scene. Alternatively, the neural network model 120 can be trained using semi-supervised training techniques, where the training samples include both reference labels and unlabeled data for detecting and tracking objects captured in a scene.

For situations where the multiple sensors are image sensors and the sequences of input data 110 are sequences of image frames, the neural network model 120 can be a convolutional neural network, which is trained to process the RGB channels or the YUV channels of the sequence of input image frames captured by each image sensor. The output generated from the convolutional neural network 120 for the input sequence of image frames from an image sensor can include a set of two-dimensional (2D) bounding boxes in the image space (or the sensor space for generality). More specifically, each bounding box encloses at least a part of a detected object in that image frame. The bounding boxes associated with a tracked object can change their locations, sizes, and orientations across different frames as the tracked object navigates with respect to the location of the image sensor. The bounding boxes for different objects in a single frame of the sequence of frames are generally associated with data representing the locations of the objects, which can be specified by the upper-left coordinates of the bounding boxes. The bounding boxes are further associated with data representing dimensions (e.g., the length and width) of tracked objects in the frame, predicted classes for the objected in the frame, and the heading directions for the tracked objects in the frame relative to the location and orientation of the image sensor. In some implementations, a heading direction can be defined by an angle between the object's facing direction and the image sensor's focal direction, where the focal direction of an image sensor generally aligns with the line that is defined by the center of projection (e.g., the pinhole or the sensor center) and the focal point of the image sensor.

In some implementations, system 100 processes the input data 110 using the neural network model 120 with one or more additional algorithms. For example, system 100 can process the network data sequence 130 using a Kalman filter and the Hungarian algorithm to generate tracking information in the 2D image space. More specifically, a Kalman filter is an algorithm that estimates the state of a dynamic system over time, even in the presence of noise. For tracking objects captured in 2D images, the Kalman filter first predicts the object's next position in the next frame based on its current motion status such as velocity, acceleration, past positions, heading direction, or other dynamic properties in the current frame. The Kalman filter further updates its prediction by comparing an observed position of the object for the next frame with the predicted position to filter out noises.

The Hungarian algorithm is an algorithm configured to assign predicted motions for detected objects. More specifically, the Hungarian algorithm is configured to associate detected positions in the current frame with the tracked objects from the previous frame by minimizing a cost function. For example, the cost function can be formulated based on the distance between the predicted and observed positions of different objects. In some implementations, the Hungarian algorithm can assign a unique identifier to a tracked object across different frames. The unique identifier can further indicate the tracking status of a tracked object, e.g., an object that has been tracked, a newly tracked object, or a lost object.

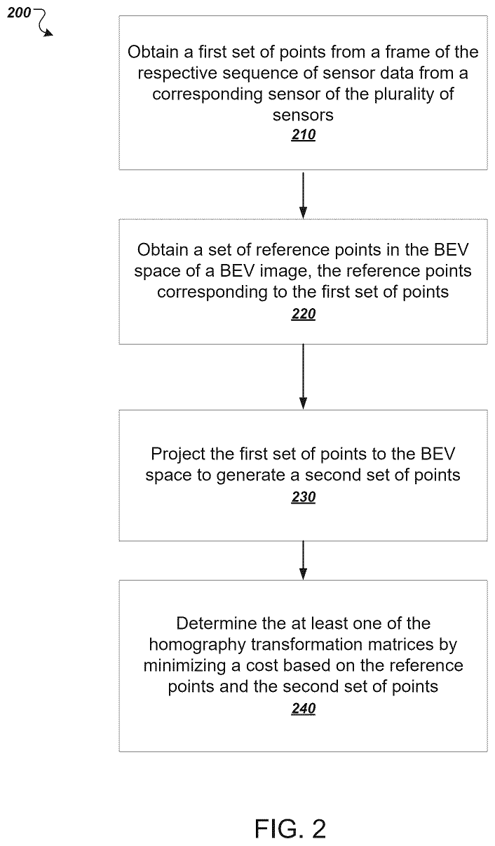

Before further processing the network data sequences 130, system 100 determines one or more homography transformation matrices to align the 2D image space with the BEV space. The homography transformation matrices generally map the points or pixels in the 2D images to the points or pixels in the BEV space. More details of the process of determining or updating a homography transformation matrix are described below in connection with FIG. 2. Note that although the technqieus described herein are illustrated using homography transformation matrices, other types of transformation matrices (e.g., affine transformation matrices) can be used to satisfy various transformation requirements.

After obtaining the one or more homography transformations and the network data sequences 130 for input data 110 from all sensors, the system processes the network data sequences 130 using the BEV fusion engine 140 to fuse the information from multiple sensors to generate data that represents a set of tracked objects in the BEV space across multiple frames. The data representing the set of tracked BEV objects are provided as output data 180 by system 100. In some implementations, the output data 180 further includes characteristic information associated with the tracked BEV objects. For example, the characteristic information can include a position, a dimension, a class, a heading direction, or a visualization representation of a trakced object in the set of tracked objects in the BEV space. The characteristic information can also include a velocity, a motion status, a geographic coordinate, or other suitable information associated with a tracked object of the set of tracked objects in the BEV space. More details of the functions and operations performed by the BEV fusion engine 140 are described below in connection with FIG. 5.

In addition, system 100 can be communicatively coupled with a memory unit 190. Memory unit 190 can be local or remote to system 100. In some cases, memory unit 190 is generally configured to store parameters for system 100. For example, memory unit 190 can store model parameters for the neural network model 120, the homography transformation matrices, the instructions to cause the BEV fusion engine 140 to perform corresponding fusion operations, etc. Memory unit 190 can also provide these stored parameters to system 100 for performing operations to process input data 110. In addition, the memory unit 190 may optionally be configured to store and provide input data 110 to system 100, or temporarily store output data 180, or both.

System 100 can be communicatively coupled to a server 195. Server 195 generally receives user requests for processing input data 110 using the system 100. In some implemenations, server 195 can receive and further process output data 180 to generate real-time instructions to provide real-time traffic updates and warnings about potential hazards. In some cases, server 195 can generate instructions that, once executed by system 100, cause system 100 to process input data 110 using alternative algorithms or methods. More details of alternative algorithms are described below in connection with FIG. 5.

FIG. 2 is a flow diagram of an example process 200 for generating a homography transformation matrix. For convenience, the example process 200 is described as being performed by a system of one or more computers located in one or more locations. For example, the BEV object tracking system 100 of FIG. 1, when appropriately programmed, can perform the process 200.

As described above, the system can generate a mapping between the sensor space and the BEV space by determining one or more homography transformation matrices. The sensor space generally refers to the local coordinates of one or more points in the local coordinate frame with respect to a corresponding sensor. The BEV space generally refers to the global coordinates of corresponding points in the global coordinate frame. For example, the global coordinate of a point can be a physical location according to the geometric data, e.g., the longitude and latitude of the point. The local coordinates of a point can be a location and an orientation relative to that of the corresponding sensor. The system is configured to project the points in the image space with local coordinates into the BEV space with global coordinates.

For situations where the sensors are cameras with fixed locations and orientations, the BEV space generally refers to a space represented by a BEV image. The BEV image can be obtained using various techniques. For example, the system can use a LiDAR sensor to obtain the top-down view encompassing the scene of interest. As another example, the system can use a drone to take aerial images of the scene of interest. Yet as another example, the system can use a map system or GPS system to set up the BEV image and the corresponding BEV space.

In general, a homography transformation matrix can map a portion of data points in a frame of sensor data to a corresponding set of points in the BEV space. Thus, for a full mapping between the BEV space and the sensor space, the system generally needs to obtain or update more than one homography transformation matrices for different sets of point pairs, each pair of points representing a point or pixel in a frame of a sensor data and a corresponding point or pixel in the corresponding frame in the BEV image.

As described above, the system can calibrate the BEV space and the image space to update a homography transformation matrix. The system obtains a first set of points from a frame of the respective sequence of sensor data from a corresponding sensor of the plurality of sensors (210). The first set of points generally refers to the ground points in the frame of sensor data. Ground points generally refer to pixels representing points of an object that are located on the ground level (e.g., on the road).

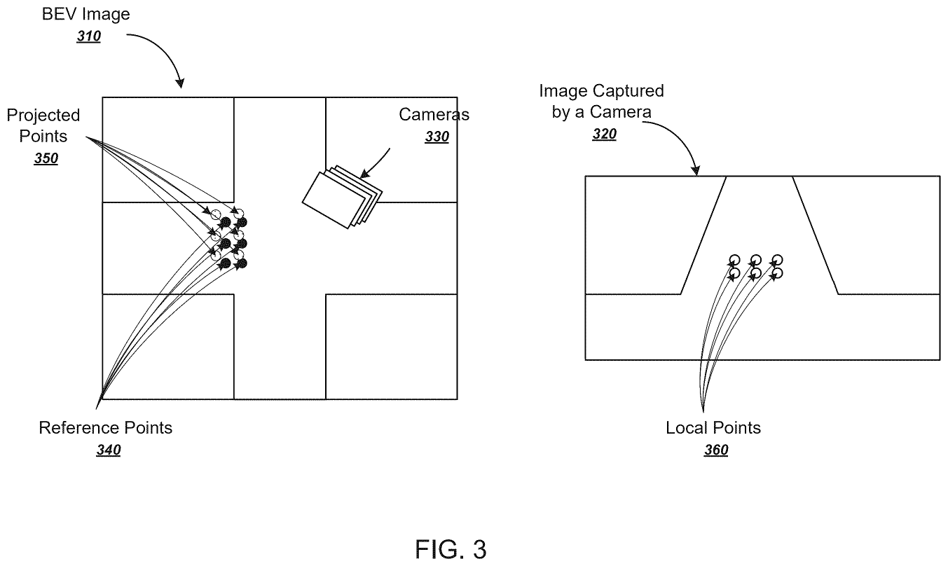

For example, as shown in FIG. 3 that illustrates an example of correspondence between points in a BEV image 310 and an image 320 captured by a camera 330, the first set of points can be local points 360 in an image frame 320. The local points 360 generally relate to ground points on the road captured in the image frame 320. These local points 360 can be marked or selected manually or by one or more algorithms. For example, a user or technician can initially mark or select a sparse set of local points representing landmarks such as road markers in the image frame 320. The user or technician can then automatically use one or more algorithms to generate additional local points. The algorithms can include key point selection algorithms such as the Harris corner detection algorithm, the Scale-Invariant Feature Transform (SIFT) algorithm, or other suitable algorithms to densify the local points.

The system obtains a set of reference points in the BEV space of a BEV image (220). The reference points in the BEV image (or BEV space) correspond to the first set of points in the image space. The reference points can be obtained manually or using one or more algorithms, as described above. The reference points generally refer to benchmark locations where the first set of points should be projected if the sensors and the BEV space are optimally calibrated.

For example and as shown in FIG. 3, the reference points in the BEV image can be reference points 340 in the BEV image 310. As described above, the BEV image 310 can be an image taken by a LiDAR sensor or a drone or can be an image obtained by a map using a navigation or GPS system. The reference points 340 represent locations where the corresponding local point 360 should be projected if the calibration process is optimized.

The system projects the first set of points to the BEV space to generate a second set of points (230). More specifically, the system can employ one or more computer vision algorithms to compute a mapping from the first set of points in the image space to a second set of points in the BEV space. The mapping itself can be represented by a homography transformation matrix. As an example shown in FIG. 3, the system uses one or more computer vision algorithms to generate a set of projected points 350 in the BEV image 310 from the local points 360 in the image 320 captured by the corresponding camera 330.

The system determines at least one of the homography transformation matrices by minimizing a cost based on the reference points and the second set of points. (240). As shown in FIG. 3, before calibration (or until the calibration is optimized), the projected points 350 and the reference points 340 usually mismatch (or do not substantially overlap). The system then adjusts the parameters in the homography transformation matrix by reducing the mismatch. For example, the mismatch can be measured by a mismatch cost representing one or more distances between the reference points and the projected points from the local points in the BEV space. The system can update the homography transformation matrix by minimizing the mismatch cost. The above-noted computer vision algorithms can include the direct linear transform (DLT) algorithm configured to update the homography transformation matrices.

As described above, the mapping process generally relates to multiple sets of local points in the image space and their corresponding sets of projected points in the BEV space. Thus, the system needs to determine and update multiple transformation matrices for mapping points to cover at least a substantial portion of the BEV space. Thus, for each set of local points in the image space, the system repeatedly performs the above-noted operations to update a respective homography transformation matrix for the set of local points by minimizing a respective mismatch cost.

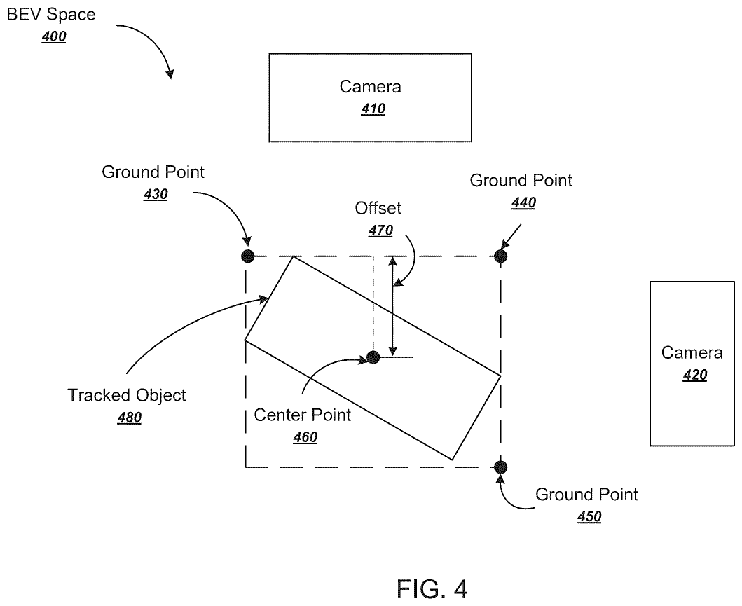

FIG. 4 illustrates an example of determining the center point 470 of a tracked object 480 in the BEV space 400. The system performs this operation step as a part of operations to generate bounding boxes for objects (or points) projected in the BEV space based on sensor data captured by multiple sensors. The bounding boxes are also referred to as BEV bounding boxes for simplicity in the following description. More specifically, the system performs the operations to generate BEV bounding boxes after (i) optimizing the homography transformation matrices and (ii) generating the network data sequences for input data using the neural network model (e.g., the neural network model 120 of FIG. 1.) Note that the optimization of homography transformation matrices and the generation of network data sequences can be swapped in order according to different requirements of detecting and tracking objects using sensor data.

The system generally generates the BEV bounding boxes based on the detection and tracking information represented in the network data sequences and the optimized homography transformation matrices. As described above, each frame in the network data sequences for a sequence of sensor data from a corresponding sensor can include a set of two-dimensional (2D) bounding boxes for objects detected and tracked in the frame. Each bounding box encloses at least a portion of a detected object in that frame. The bounding boxes are associated with data representing the locations of the objects, dimensions (e.g., the length and width) of tracked objects in the frame, predicted classes for the objected in the frame, and the heading directions for the tracked objects in the frame relative to the location and orientation of the image sensor.

Note that, in some implementations, the heading direction of a tracked object in the BEV space can be calculated by tracking either the left or right ground point of the tracked object in the BEV space, without relying on the heading direction calculated in the image space by the neural network model. The system can directly apply a polynomial fit to the trace of these ground points to determine the heading direction in the BEV space for that object.

The system is configured to estimate characteristic information for the BEV bounding boxes in the BEV space based on the detection and tracking information in the network data sequences. For example, the system can determine a BEV bounding box for a tracked object in the BEV space using a pre-determined template for that class of object. For example, the tracked object can be predicted to a class by the neural network model, and the system can assign a template for that trakced object with a predetermined set of dimensions (width, length, height, size, etc.). The system can generally assign a template for a class predicted by the neural network. For example, the templates can be predetermined for classes such as sedans, buses, SUVs, bicycles, motorcycles, or other suitable classes. As another example, a truck can be assigned with a different class, e.g., pickup truck class, trailer truck class, or other suitable classes. The system needs to extract geometric information from a corresponding class template (e.g., a truck class template) to determine positions and orientations for a particular class (e.g., the trailer truck).

The system is further configured to determine the BEV heading directions for tracked objects in the BEV space. More specifically, the system can infer the BEV heading directions based on the heading directions predicted in the image space and the sensors'locations in the BEV space.

The system is further configured to determine a location of a tracked object in the BEV space. In some implementations, the location of a trakced object in the BEV space is represented by a center point of the tracked object in the BEV space. As an example shown in FIG. 4, center point 460 of the tracked object 480 in the BEV space 400 can represent a location of the tracked object in the BEV space 400.

The system determines the center point of a tracked object in the BEV space based on a set of reference points and an offset value for the tracked object in the BEV space. In some implementations, the reference points are associated with one or more ground points for the same tracked object in the image space (e.g., image frames captured by one or more sensors). The offset value, on the other hand, generally refers to the size of a pre-determined template assigned for that object class.

As shown in FIG. 4, the reference points generally relate to ground points 430, 440, and 450. As described above, ground points generally refer to points where a tracked object touches the ground (or pixels representing the ground surface where the trakced object stands) in a corresponding frame of sensor data captured by a corresponding sensor. For example, for the tracked object 480, the ground points for sensor data captured by camera 410 are ground points 430 and 440, and the ground points for sensor data captured by camera 420 are ground points 440 and 450.

For sensor data captured by camera 410, the system determines a midpoint of the corresponding ground points (e.g., 430 and 440) and shifts the midpoint by the offset 470 to determine the center point 460 of the tracked object 480. The offset value generally relates to half of the length or width of a tracked object. As described above, the length or width of a trakced object is determined based on a predetermined template assigned for the class of the tracked object. The offset value further relates to the heading direction of the object in the BEV space. The process of determining the heading directions for trakced objects in the BEV space is described above.

In some implementations, the system can estimate a height of the trakced object based on a predetermined template for the class of the trakced object. The estimated height information can be used for identifying occluded objects. Alternatively, the system can train and use a machine learning model to predict visibility attributes instead of relying on the estimated heights using the predetermined templates.

FIG. 5 is a flow diagram of an example process 500 for processing input data to detect unlabeled objects. For convenience, the example process 500 is described as being performed by a system of one or more computers located in one or more locations. For example, the BEV object tracking system 100 of FIG. 1, when appropriately programmed, can perform the process 500.

First, the system receives a respective sequence of sensor data from each of a plurality of sensors (510). As described above, the system can process sensor data obtained from multiple sensors. The multiple sensors can be located in the vicinity or at different locations to capture a common scene from a different perspective. The sensor data generally includes multiple data sequences, where each sequence is obtained by a respective sensor. The sensors can have various types, such as an image sensor, an optical sensor such as LiDAR, a radio signal sensor such as a radar, or other suitable types of sensors. For situations where the sensors include one or more cameras, the sequences of sensor data can include multiple sequences of two-dimensional image frames, where each sequence of image frames is captured by a respective camera.

The system processes each of the respective sequences of sensor data using a neural network to generate a respective network output that represents detection and tracking information for corresponding objects captured in the respective sequence of sensor data (520). As described above, the system employs a neural network model to process each sequence of sensor data captured by a respective sensor to generate a network output. The network output generally includes a respective network data sequence for each input sequence of sensor data.

Each network data sequence generally includes a sequence of tracked objects in the image space across different frames on the network data sequence. One or more tracked objects can be present in a subset of frames of the network data sequence since the physical objects might move in and out of the scene measured by the sensor. In addition, the tracked objects in the network data sequences are generally identified by corresponding bounding boxes in the image space for each frame of the sequence of frames. The bounding boxes might change sizes, locations, and orientation across different frames due to the motion of the tracked changes. The bounding boxes across different frames for a tracked object can be further associated with data representing the object location, the dimensions, the class, the heading direction, or a unique identifier associated with the tracked object.

For each of the respective network outputs, the system transforms the respective network output to a bird's eye view (BEV) space to generate a BEV data sequence representing a set of tracked objects in the BEV space (530). More specifically, the system first determines a mapping between points (or pixels) in the image space and the BEV space using one or more homography transformation matrices. The detailed process of updating or optimizing a homography transformation matrices is described above.

The system further generates BEV bounding boxes for trakced objects in the BEV space using the homography transformation matrices and the network data sequences generated by the neural network model for input sensor data. In general, the BEV characteristic information for the BEV bounding boxes corresponds to characteristic information generated for trakced objects in the image space by the neural network model, as described above.

The system estimates the BEV characteristic information of the BEV bounding boxes based on the network data sequences generated by the neural network model for input data in the image space. For example, the BEV characteristic information includes data representing a location, a dimension, or a heading direction of a tracked object in the BEV space. Note that the heading direction for the tracked object in the BEV space is determined based on the BEV location of a corresponding sensor of the plurality of sensors in the BEV space and a heading direction of the object in the sensor data that is determined by the neural network model. As described above, the location of the object in the BEV space is determined based on one or more BEV reference points and an offset value. The one or more BEV reference points are determined based on the ground points of the object in the corresponding sensor data, e.g., the midpoint of a pair of ground points. The offset value is determined based on the heading direction for the object in the BEV space and the dimension data of the object, as described above.

After the system generates the BEV bounding boxes in the BEV space, the system further clusters these BEV bounding boxes into multiple clusters and loops over these clusters to assign a unique identifier that represents a respective tracked object in the BEV space. The unique identifiers are also associated with the tracked objects captured in the image space from sensor data.

More specifically, to generate clusters of BEV bounding boxes for each frame of multiple frames, the system first obtains the BEV bounding boxes in that frame generated by all network data sequences from multiple sensors. In other words, for each corresponding frame in the all network data sequences, the system fuses all BEV bounding boxes for all network data sequences into a single BEV frame. Then, for each pair of bounding boxes in the frame that are not from the same network data sequences (i.e., so that the pair of bounding boxes is generated by sensor data from different sensors), the system computes an Intersection over Union (IoU) value for the pair. Note that the system accounts for orientation differences (e.g., rotations between bounding boxes) when calculating the IoU values.

Based on the IoU values, the system assigns bounding boxes into clusters to reach a maximum overall IoU value. The system can further compute a sum of the IoU value for each luster of the assigned bounding boxes. Note that each cluster only includes bounding boxes obtained by sensor data from different sensors, as described above.

The system repeatedly performs the above-noted operations for every frame of the sequence of frames in the network data sequences to generate a respective set of clusters of BEV bounding boxes for each frame of the multiple frames.

In some implementations, the system can generate clusters based on the distances between tracked objects (or bounding boxes) without computing the IoU values. The system can use the distances to filter out tracked objects that are more identifiable and easily matched than the other ones. This way, the system can significantly reduce the computational cost needed to compute the IoU values, improving the efficiency of the fusing and tracking function. Although the distance-based approach might reduce the cost of accuracy, it still provides results with a reasonable level of overall accuracy.

After generating the clusters for each frame of the sequence of frames, the system initializes data to generate a set of tracked objects in the BEV space for the first frame in the sequence of multiple frames. Note that the set of tracked objects is represented by the BEV bounding box clusters in the first frame. In some implementations. the system can select the sensor nearest to the scene as the principal sensor for higher accuracy.

After initializing the set of tracked objects in the BEV space, the system updates the initialized set of tracked objects for each subsequence frame in the sequence. More specifically, for a frame that is immediately after the first frame in the sequence, the system updates the initialized set of trakced objects. More specifically, the system updates the set by matching each tracked object in the frame with a corresponding cluster of bounding boxes for the tracked object. The tracked object can be labeled using a unique identifier determined by the neural network model in the sensor space (or 2D image space), as described above. The system updates the set of tracked objects based on the matching results. Note that the system leverages the detection and tracking information generated by the neural network model in the image space for the matching process, which tends to be more robust than directly tracking objects using bounding boxes in the BEV space.

In the matching process, the system determines whether one of the set of tracked objects in the frame matches with more than one of the clusters of BEV bounding boxes in the frame. In response to determining that the tracked object matches with more than one of the clusters of BEV bounding boxes in the frame, the system computes, for each of the matching clusters, a matching cost to represent a change of position and heading direction of the matching cluster between an immediately preceding frame and the frame, and selects one of the matching clusters as the cluster to match with the tracked object in the frame based on the matching costs. For example, the system selects the cluster associated with the minimal matching cost as the matching cluster for that tracked object in the frame.

In some situations, when the system determines that one object of the set of tracked objects in the frame does not match any of the clusters of BEV bounding boxes in the frame, the system updates the location of the tracked object for the frame using a motion model and calculates an IoU value using the updated location over each of the remaining clusters of the clusters of the BEV bounding boxes for the frame. The motion model can be the Kalman filter, which is described in greater detail above.

If the system determines that the IoU value calculated for one of the remaining clusters exceeds a threshold IoU value, the system determines that the unmatched object matches the corresponding clusters associated with the IoU value. The system subsequently updates the set of tracked objects to reflect the new matches for the frame. However, if the IoU value does not exceed a threshold IoU value, the system determines a no-match. Then, the system increases the threshold consecutive miss value and recalculates an IoU value with the unmatched object using the increased threshold consecutive miss value over each of the remaining clusters of the clusters of the BEV bounding boxes for the frame. If the new IoU value using the increased threshold consecutive miss value exceeds the threshold IoU value, the system determines a match between the tracked object and the clusters of BEV bounding boxes associated with the new IoU value. The system updates the set of trakced objects accordingly.

However, if the new IoU value is still below the threshold IoU value, the system repeatedly increases the threshold consecutive miss value to try to find a match until the threshold consecutive miss value exceeds a maximum permissible value. In that case, the system determines that the tracked object is lost and removes that object from the set of tracked objects. The threshold IoU value can be 0.2, 0.3, 0.4, or other suitable values. The threshold consecutive value and the maximum permissible value are scene-specific, and can vary according to different scenes and tracking requirements. As naïve examples, the threshold consecutive miss values can be 1, 2, 3, 5, or other suitable values. The maximum permissible value can be 5, 8, 10, or other suitable values.

Moreover, the system further initializes a set of new trakced objects for the remaining clusters that are not matched with any object in the set of tracked objects. The system can repeatedly perform the above-desribed operations to reach a stop point. The stop point can relate a total number of iterations, a total number of remaining unmatched objects, or other suitable cretria for stop points.

Based on the BEV data sequence, the system generates characteristic information for at least a portion of the set of tracked objects (540). More specifically, if a tracked object has a substantial tracking history (e.g., matched in a number of frames that exceeds a threshold number), the system determines that the tracked object is valid in the BEV space. The system then extracts characteristic information associated with the tracked object, which is represented by the clusters of BEV bounding boxes matching the tracked object, as described above. The characteristic information for the tracked object in the BEV space includes a position, one or more dimensions, a class, a heading direction, or an identifier associated with the tracked object.

In addition, the system can further extract information such as velocity, motion status, geographic coordinates, or other suitable data that can be calculated based on the characteristic information associated with the tracked object. The system can provide the characteristic information for downstream operations to generate output for further applications, such as providing real-time traffic updates and warnings about potential hazards, as described above.

The term “machine learning model” throughout the specification stands for any suitable model used for machine learning. As an example, the machine learning model can include one or more neural networks trained for performing different inference tasks. Examples of neural networks and tasks performed by neural networks are described in greater detail at the end of the specification. For simplicity, the term “machine learning models” is sometimes referred to as “neural network models” or “deep neural networks” in the following specification.

Depending on the task, a neural network can be configured, i.e., through training, to receive any kind of digital data input and to generate any kind of score, classification, or regression output based on the input.

In some cases, the neural network is a neural network that is configured to perform an image processing task, i.e., receive an input image and process the input image to generate a network output for the input image. In this specification, processing an input image refers to processing the intensity values of the pixels of the image using a neural network. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual image processing or computer vision tasks, i.e., by generating the output for the multiple different individual image processing tasks in parallel by processing a single input image.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language specification, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it, software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising: receiving a respective sequence of sensor data from each of a plurality of sensors; processing each of the respective sequences of sensor data using a neural network to generate a respective network output that represents detection and tracking information for corresponding objects captured in the respective sequence of sensor data; for each of the respective network outputs, transforming the respective network output to a bird's eye view (BEV) space to generate a BEV data sequence representing a set of tracked objects in the BEV space; and generating characteristic information for at least a portion of the set of tracked objects based on the BEV data sequence.

Embodiment 2 is the method of Embodiment 1, wherein the sequences of sensor data comprise sequences of two-dimensional image frames obtained by the plurality of sensors, and wherein the plurality of sensors comprise one or more cameras.

Embodiment 3 is the method of Embodiment 1 or 2, wherein transforming the respective network output to the BEV space comprises transforming the respective network output to the BEV space using one or more transformation matrices.

Embodiment 4 is the method of Embodiment 3, wherein at least one of the one or more homography transformation matrices is a homography transformation matrix, and where in the homography transformation matrix is determined by obtaining a first set of points from a frame of the respective sequence of sensor data from a corresponding sensor of the plurality of sensors, obtaining a set of reference points in the BEV space of a BEV image, the reference points corresponding to the first set of points; projecting the first set of points to the BEV space to generate a second set of points; and determining the homography transformation matrix by minimizing a cost based on the reference points and the second set of points.

Embodiment 5 is the method of any one of Embodiments 1-4, wherein the detection and tracking information for the respective network output comprises a network data sequence representing, for each frame of a plurality of frames in the network data sequence, a set of two-dimensional bounding boxes for one or more objects captured in the frame.

Embodiment 6 is the method of Embodiment 5, wherein the detection and tracking information further comprises a location, a dimension, a class, a heading direction, or an identifier for each of the corresponding objects captured in each frame of the plurality of frames in the network data sequence.

Embodiment 7 is the method of Embodiment 5 or 6, wherein for each of the respective network outputs, transforming the respective network output to the BEV space to generate the BEV data sequence representing the set of tracked objects in the BEV space comprises for each frame of the network data sequence, generating a BEV bounding box for each of the corresponding objects in the respective network output.

Embodiment 8 is the method of Embodiment 7, further comprising generating BEV characteristic information corresponding to the BEV bounding box based on a homography transformation matrix, wherein the BEV characteristic information comprises a location, a dimension, or a heading direction for the corresponding object in the BEV space.

Embodiment 9 is the method of Embodiment 8, wherein the heading direction for the object in the BEV space is determined based on a BEV location of a corresponding sensor of the plurality of sensors and a heading direction of the object in the sensor data determined by the neural network.

Embodiment 10 is the method of Embodiment 9, wherein the location of the object in the BEV space is determined based on one or more BEV reference points and an offset value, wherein the one or more BEV reference points are determined based on ground points of the object in the corresponding sensor data, and wherein the offset value is determined based on the heading direction for the object in the BEV space and dimension data of the object.

Embodiment 11 is the method of any one of Embodiments 7-10, further comprising: for each corresponding frame of the network data sequences, generating clusters of BEV bounding boxes for the corresponding objects, wherein the generating comprises: obtaining the BEV bounding boxes for the corresponding frame of the network data sequences associated with the plurality of sensors; for each pair of BEV bounding boxes that are not associated with the same sensor if the plurality of sensors, computing an Intersection over Union (IoU) value; and clustering the BEV bounding boxes based on the IoU values.

Embodiment 12 is the method of Embodiment 11, further comprising summing the IoU values for each cluster of the clusters of BEV bounding boxes.

Embodiment 13 is the method of Embodiment 11 or 12, further comprising initiating a set of tracked objects in the BEV space for the first frame of the BEV data sequence based on the clusters of BEV bounding boxes.

Embodiment 14 is the method of Embodiment 13, further comprising: for each frame succeeding the first frame and for each object in the set of tracked objects, matching an identifier for the object with one of the clusters of the BEV bounding boxes in the frame, wherein the identifier is associated with the object by the neural network, and updating the set of tracked objects for the frame based on the matching result.

Embodiment 15 is the method of Embodiment 14, further comprising: determining whether one of the set of tracked objects in the frame matches with more than one of the clusters of BEV bounding boxes in the frame, in response to determining that the tracked object matches with more than one of the clusters of BEV bounding boxes in the frame, computing, for each of the matching clusters, a matching cost to represent a change of position and heading direction of the matching cluster between an immediately preceding frame and the frame, and selecting one of the matching clusters as the cluster to match with the tracked object based on the matching costs.

Embodiment 16 is the method of Embodiment 14 or 15, further comprising: determining whether one of the set of tracked objects in the frame does not match any of the clusters of BEV bounding boxes in the frame, in response to determining that one of the set of tracked objects in the frame does not match any of the clusters of BEV bounding boxes in the frame, updating a location of the tracked object for the frame using a motion model, and calculating an IoU value using the updated location for each of the remaining clusters of the clusters of the BEV bounding boxes for the frame.

Embodiment 17 is the method of Embodiment 16, further comprising determining whether the IoU value calculated for one of the remaining clusters exceeds a threshold IoU value, and in response to determining that the IoU value calculated for one of the remaining clusters exceeds the threshold IoU value, matching the track object with the cluster associated with IoU value.

Embodiment 18 is the method of Embodiment 16 or 17, further comprising: determining whether the IoU value calculated for one of the remaining clusters exceeds a threshold IoU value, in response to determining that the IoU value calculated for one of the remaining clusters does not exceed the threshold IoU value, repeatedly increasing a threshold consecutive miss value and updating the IoU value based on the increased threshold consecutive miss value, and in response to determining that the threshold consecutive miss value exceeds a maximum permissible value, removing the tracked object from the set of tracked objects.

Embodiment 19 is a system comprising one or more computers and one or more storage devices storing instructions that when executed by one or more computers cause the one or more computers to perform respective operations, the operations comprising the method of any one of Embodiments 1-18.

Embodiment 20 is one or more computer-readable storage media storing instructions that when executed by one or more computers cause the one or more computers to perform respective operations, the respective operations comprising the method of any one of Embodiments 1-18.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A method, comprising:
receiving a respective sequence of sensor data from each of a plurality of sensors;
processing each of the respective sequences of sensor data using a neural network to generate a respective network output that represents detection and tracking information for corresponding objects captured in the respective sequence of sensor data;
for each of the respective network outputs, transforming the respective network output to a bird's eye view (BEV) space to generate a BEV data sequence representing a set of tracked objects in the BEV space; and
generating characteristic information for at least a portion of the set of tracked objects based on the BEV data sequence.

2. The method of claim 1, wherein the sequences of sensor data comprise sequences of two-dimensional image frames obtained by the plurality of sensors, and wherein the plurality of sensors comprise one or more cameras.

3. The method of claim 1, wherein transforming the respective network output to the BEV space comprises:
transforming the respective network output to the BEV space using one or more transformation matrices.

4. The method of claim 3, wherein at least one of the one or more homography transformation matrices is a homography transformation matrix, and where in the homography transformation matrix is determined by:
obtaining a first set of points from a frame of the respective sequence of sensor data from a corresponding sensor of the plurality of sensors,
obtaining a set of reference points in the BEV space of a BEV image, the reference points corresponding to the first set of points;
projecting the first set of points to the BEV space to generate a second set of points; and
determining the homography transformation matrix by minimizing a cost based on the reference points and the second set of points.

5. The method of claim 1, wherein the detection and tracking information for the respective network output comprises a network data sequence representing, for each frame of a plurality of frames in the network data sequence, a set of two-dimensional bounding boxes for one or more objects captured in the frame.

6. The method of claim 5, wherein the detection and tracking information further comprises a location, a dimension, a class, a heading direction, or an identifier for each of the corresponding objects captured in each frame of the plurality of frames in the network data sequence.

7. The method of claim 5, wherein for each of the respective network outputs, transforming the respective network output to the BEV space to generate the BEV data sequence representing the set of tracked objects in the BEV space comprises:
for each frame of the network data sequence, generating a BEV bounding box for each of the corresponding objects in the respective network output.

8. The method of claim 7, further comprising:
generating BEV characteristic information corresponding to the BEV bounding box based on a homography transformation matrix,
wherein the BEV characteristic information comprises a location, a dimension, or a heading direction for the corresponding object in the BEV space.

9. The method of claim 8, wherein the heading direction for the object in the BEV space is determined based on a BEV location of a corresponding sensor of the plurality of sensors and a heading direction of the object in the sensor data determined by the neural network.

10. The method of claim 9, wherein the location of the object in the BEV space is determined based on one or more BEV reference points and an offset value,
wherein the one or more BEV reference points are determined based on ground points of the object in the corresponding sensor data, and
wherein the offset value is determined based on the heading direction for the object in the BEV space and dimension data of the object.

11. The method of claim 7, further comprising:
for each corresponding frame of the network data sequences, generating clusters of BEV bounding boxes for the corresponding objects, wherein the generating comprises:
obtaining the BEV bounding boxes for the corresponding frame of the network data sequences associated with the plurality of sensors;
for each pair of BEV bounding boxes that are not associated with the same sensor if the plurality of sensors, computing an Intersection over Union (IoU) value; and
clustering the BEV bounding boxes based on the IoU values.

12. The method of claim 11, further comprising:
summing the IoU values for each cluster of the clusters of BEV bounding boxes.

13. The method of claim 11, further comprising:
initiating a set of tracked objects in the BEV space for the first frame of the BEV data sequence based on the clusters of BEV bounding boxes.

14. The method of claim 13, further comprising:
for each frame succeeding the first frame and for each object in the set of tracked objects, matching an identifier for the object with one of the clusters of the BEV bounding boxes in the frame, wherein the identifier is associated with the object by the neural network, and
updating the set of tracked objects for the frame based on the matching result.

15. The method of claim 14, further comprising:
determining whether one of the set of tracked objects in the frame matches with more than one of the clusters of BEV bounding boxes in the frame,
in response to determining that the tracked object matches with more than one of the clusters of BEV bounding boxes in the frame, computing, for each of the matching clusters, a matching cost to represent a change of position and heading direction of the matching cluster between an immediately preceding frame and the frame, and
selecting one of the matching clusters as the cluster to match with the tracked object based on the matching costs.

16. The method of claim 14, further comprising:
determining whether one of the set of tracked objects in the frame does not match any of the clusters of BEV bounding boxes in the frame,
in response to determining that one of the set of tracked objects in the frame does not match any of the clusters of BEV bounding boxes in the frame, updating a location of the tracked object for the frame using a motion model, and
calculating an IoU value using the updated location for each of the remaining clusters of the clusters of the BEV bounding boxes for the frame.

17. The method of claim 16, further comprising:
determining whether the IoU value calculated for one of the remaining clusters exceeds a threshold IoU value, and
in response to determining that the IoU value calculated for one of the remaining clusters exceeds the threshold IoU value, matching the track object with the cluster associated with IoU value.

18. The method of claim 16, further comprising:
determining whether the IoU value calculated for one of the remaining clusters exceeds a threshold IoU value,
in response to determining that the IoU value calculated for one of the remaining clusters does not exceed the threshold IoU value, repeatedly increasing a threshold consecutive miss value and updating the IoU value based on the increased threshold consecutive miss value, and
in response to determining that the threshold consecutive miss value exceeds a maximum permissible value, removing the tracked object from the set of tracked objects.

19. A system comprising one or more computers and one or more storage devices storing instructions that when executed by one or more computers cause the one or more computers to perform respective operations, the operations comprising:
receiving a respective sequence of sensor data from each of a plurality of sensors;
processing each of the respective sequences of sensor data using a neural network to generate a respective network output that represents detection and tracking information for corresponding objects captured in the respective sequence of sensor data;
for each of the respective network outputs, transforming the respective network output to a bird's eye view (BEV) space to generate a BEV data sequence representing a set of tracked objects in the BEV space; and
generating characteristic information for at least a portion of the set of tracked objects based on the BEV data sequence.

20. One or more computer-readable storage media storing instructions that when executed by one or more computers cause the one or more computers to perform respective operations, the respective operations comprising:
receiving a respective sequence of sensor data from each of a plurality of sensors;
processing each of the respective sequences of sensor data using a neural network to generate a respective network output that represents detection and tracking information for corresponding objects captured in the respective sequence of sensor data;
for each of the respective network outputs, transforming the respective network output to a bird's eye view (BEV) space to generate a BEV data sequence representing a set of tracked objects in the BEV space; and
generating characteristic information for at least a portion of the set of tracked objects based on the BEV data sequence.
